(19) United States
(12) Patent Application Publication
(10) Pub. No.: US 2026/0111978 A1
(43) Pub. Date: Apr. 23, 2026

(54) GENERATING PATENT CLAIM CHARTS USING LARGE LANGUAGE MODELS

(71) Applicant: Patlytics, Inc., San Francisco, CA (US)

(72) Inventors: Fei-Yang Jen, New York, NY (US); Paul Lee, New York, NY (US); Nelson Tang, Brooklyn, NY (US); Hoon Kang, San Francisco, CA (US); Grace Yang, Seattle, WA (US); Yu Chuan Jason Tseng, Vancouver (CA)

(21) Appl. No.: 19/367,310

(22) Filed: Oct. 23, 2025

Related U.S. Application Data
(60) Provisional application No. 63/711,095, filed on Oct. 23, 2024.

(51) Int. Cl. G06Q 50/18; G06F 16/93

(52) U.S. Cl. CPC G06Q 50/184; G06F 16/93; G06F 2216/11

(57) ABSTRACT

A method includes: storing a patent and a file history of the patent in a data storage, collecting, labeling, and storing documentation relating to the patent in the data storage, for each chunk of the documentation, storing a vector embedding and a related chunk in a vector data structure, generating, with a language model, a version of claim constructions of the patent and a summary of the patent using the patent and the file history, creating a vector embedding for each limitation of the version of the claim constructions, identifying the vector embeddings stored in the vector data structure having the closest matches, retrieving, from the vector data structure, the chunks of documentation associated with the vector embeddings having the closest matches, and generating a claim chart using the language model based on the version of the claim constructions and the chunks of documentation associated with the closet matches.

### CROSS-REFERENCE TO RELATED APPLICATION(S)

This application claims the benefit of U.S. Provisional Patent Application No. 63/711,095, filed in the United States Patent and Trademark Office on Oct. 23, 2024, the entire disclosure of which is incorporated by reference herein.

### FIELD

The present disclosure relates to the use of language models to facilitate the generation of patent claim charts, and more particularly to the orchestration system and methodology for using the language model to more efficiently generate these charts with accurate and relevant information.

### BACKGROUND

Patent documents are typically long, technically complex, and legally nuanced. The parties involved in negotiations often cannot cost-effectively and efficiently assess the patent's scope and strength without hiring lawyers and experts, resulting in substantial legal fees and experts, who may have differing opinions, creating a considerable gap in the parties' understandings, leading to sharply different positions and very expensive and drawn-out patent litigation, where the litigation process itself becomes a part of transaction negotiation. Courts (and/or administrative law bodies such as the Patent Trial and Appeal Board (PTAB) at the United States Patent and Trademark Office (USPTO)) ultimately provide the parties with symmetrical information (e.g. scope of the patent, validity, and/or infringement determinations, etc. in its decisions) enabling the parties to eventually settle (a form of transaction) the high costs incurred to maintain the litigation as an incentive to reach a deal.

High transaction costs associated with patent dispute resolution-legal fees, expert witnesses, lengthy discovery processes-along with non-monetary costs such as distraction and delay, create opportunities for inefficient outcomes. These costs not only affect the concerned parties but also place a substantial burden on societal resources for resolving disputes (e.g., judges and jurors), disincentivizing further innovation and diminishing the promise of patents to foster innovation that benefits society. The cost inefficiency extends to opportunistic behaviors such as so-called “efficient infringement” by accused infringers or a patent practice of so-called “patent hold-up.” These parties leverage the high litigation costs to extract opportunistic settlements.

Recent advancements with generative artificial intelligence (AI) and large language models (LLM) are being used to help reduce information asymmetry and improve cost efficiency, minimizing lengthy disputes at every stage of the legal process. With capabilities such as advanced text generation, multi-modal analysis for detailed text and figures, data synthesis, and more, AI tools have the potential to improve the efficiency of a variety of legal tasks.

While language models, e.g. ChatGPT® and Llama®, are being used in the legal profession, they are not very effective for use in the patent field, particularly where generating patent claim charting e.g. infringement and validity charts, and brief writing and analysis are prone to producing false results and inaccuracies commonly referred to as “hallucinations.” Such inaccuracies and hallucinations may be difficult for humans to detect and moreover can substantially degrade the efficiency and usefulness of using language models in the patent field. Since patent claim charting (and brief and petition writing, etc.) requires being precise with language used in the patent, prior art, products, reports, etc. and technically accurate, an improved way of using language models is required to obtain accurate and efficient results. In addition, the use of public large language models (e.g., provided as a hosted service accessed through an application programming interface) may raise security and confidentiality concerns, as the data is being supplied to a third-party service provider.

The above information disclosed in this Background section is only for enhancement of understanding of the present disclosure, and therefore it may contain information that does not form the prior art that is already known to a person of ordinary skill in the art.

### SUMMARY

In the following detailed description, only certain exemplary embodiments of the present invention are shown and described, by way of illustration. As those skilled in the art would recognize, the invention may be embodied in many different forms and should not be construed as being limited to the embodiments set forth herein. Like reference numerals designate like elements throughout the specification.

In accordance with an aspect of the disclosure, a method and system are disclosed for orchestrating use of a language model to generate a claim chart for a patent. The method and system including retrieving the patent and the patent's file history and storing the patent and the patent's file history in a data storage, collecting documentation relating to the patent, data labeling the documentation and storing the documentation in the data storage, chunking the documentation, for each chunk of documentation, creating a vector embedding, and storing the vector embeddings and the related chunks in a vector data structure, generating, with the language model, a first version the patent's claim constructions and a summary of the patent using the patent and the patent's file history, creating a vector embedding for each limitation of the first version of the patent's claim constructions, for each vector embedding of the first version of the patent's claim constructions and the vector embeddings stored in the vector data structure, identifying the vector embeddings having the closest matches, retrieving from the first data structure the chunks of documentation associated with the vector embeddings having the closest matches, providing the language model the first version of the patent's claim construction and the documentation chunks associated with the closet matches, and using the language model to generate a claim chart including first version of the patent's claim construction and the documentation chunks associated with the closet matches.

The method and system can further include generating a validity claim chart wherein the documentation associated with the vector embeddings having the closest matches is prior art documentation or alternatively generating an infringement claim chart wherein the documentation associated with the vector embeddings having the closest matches is product documentation.

The method and system can further include providing to the language model with broader or the narrower versions of the patent's claim construction and the documentation chunks associated with the vector embeddings of the closet matches, generating versions of the claim charts with the broader or the narrower versions of the patent's claim construction and the documentation chunks associated with the closet matches, determining the patent claim construction that provides the highest chance of infringement and lowest risk of invalidating the patent or determining the patent claim construction that provides the lowest chance of infringement and the highest risk of invalidating the patent.

### BRIEF DESCRIPTION OF THE DRAWINGS

The accompanying drawings, together with the specification, illustrate exemplary embodiments of the present disclosure, and, together with the description, serve to explain the principles of the present disclosure.

FIGS. 1A, 1B, and 1C depict a flowchart of a method for generating infringement or validity claim charts using a language model, according to one embodiment of the present disclosure.

FIG. 2 is a flowchart of a method for regenerating a claim chart based on a reranking of retrieved content supplied to a language model, according to one embodiment of the present disclosure.

FIGS. 3A, 3B, and 3C depict is a flowchart of a method for generating a claim construction that is jointly optimized based on an infringement analysis and a validity analysis, and generating associated infringement and validity claim charts, according to one embodiment of the present disclosure.

FIG. 4 is a block diagram of a system for generating claim charts, according to one embodiment of the present disclosure.

FIG. 5 is a block diagram illustrating a high-level network architecture of a computing system environment for operating a processing system according to embodiments of the present disclosure.

FIG. 6 is a block diagram illustrating a representative software architecture, which may be used in conjunction with various hardware architectures as described herein.

FIG. 7 is a block diagram illustrating components of a processing circuit or a processor, according to some example embodiments, configured to read instructions from a non-transitory computer-readable medium (e.g., a non-transitory machine-readable storage medium) and perform any one or more of the methods discussed herein.

### DETAILED DESCRIPTION

In the following detailed description, only certain exemplary embodiments of the present disclosure are shown and described, by way of illustration. As those skilled in the art would recognize, the invention may be embodied in many different forms and should not be construed as being limited to the embodiments set forth herein.

A patent is a type of intellectual property that gives its owner a time-limited right to exclude others from making, using, or selling an invention. The scope of the patent rights are defined based on one or more claims, where each claim describes, in a natural language sentence, the technical subject matter to be covered. A claim may be directed to a method (in which case the claim recites one or more steps that are performed in accordance with the method), an apparatus or system (in which case the claim recites one or more components of the apparatus or system and the interrelations between those components), a chemical composition, or the like. The various parts of a claim may be referred to as “terms” and/or “limitations.”

To have a valid patent, a patent applicant or patent owner must show, among other things, that the claimed invention is novel and non-obvious (or has inventive step) over other inventive work that antedates the patent, referred to as “prior art.” During a patent examination process, a patent examiner may perform literature searches (e.g., of prior patents or published patent applications, academic papers, textbooks, and the like) to identify related work to show how each term and limitation in each claim is already taught in the prior art. A claim term or limitation is said to “read on” a portion of some prior art when the claim term or limitation is described by the prior art. A patent applicant may overcome a rejection of a patent claim by arguing that the examiner is incorrect or by amending the scopes of the rejected claims (e.g., adding more limitations that are not taught by the cited prior art).

When enforcing a patent against an infringing product sold by another party, a patent owner must show that an accused infringing product exhibits every limitation of at least one claim of that patent. Similarly, when enforcing a method claim against an accused infringing process performed by another party, the patent owner must show that the other party performs every step recited in the method claim. As above, a claim term or limitation is said to “read on” some aspect of an accused product when the accused product exhibits or contains an aspect or feature that is described by the term or limitation.

One approach to presenting the infringement analysis is in a claim chart, which is typically a table with two columns. The language of the claims may be presented in one column (e.g., the left column of the table), where each row corresponds to a different claim limitation or claim term. The other column of the table (e.g., the right column of the table) includes references to relevant documents for the infringement analysis, such as product documentation (e.g., user manuals, datasheets, and the like) showing that the accused product exhibits the claim limitation seen in the same row. This term-by-term or limitation-by-limitation mapping helps to increase confidence that each term or limitation has been addressed in the infringement analysis. The claim chart could also include an additional column. This additional column could include a claim construction for the claims.

A defendant in a patent infringement dispute may prepare a similar claim chart to present reasons why the accused product or process does not exhibit the terms or limitations recited in the claims. In addition, a defendant may also attempt to invalidate the asserted patent claims by identifying prior art that describes all of the terms and limitations of the claims. Such an validity analysis may also be presented in a claim chart, with claim terms and limitations in one column and with targeted citations to portions of the prior art in the other column. The claim chart could also include an additional column. This additional column could include a claim construction for the claims.

The infringement analysis and invalidity analysis both rely on interpreting the language of the claims. While some claim terms or limitations may be unambiguous, the patent owner and the accused infringer may disagree on the meaning of other terms or limitations of the claims. The interpretations of claim terms are referred to as a claim construction, in that the different parties may construe terms and limitations in different ways. A claim construction is referred to as being broad when it encompasses a larger set or scope of possibilities and is referred to as being narrow when it encompasses a smaller set or scope of possibilities.

A broader claim construction generally means that the claim can be asserted or enforced against a wider range of products, but also makes the claim more vulnerable to invalidity, because a wider range of prior art can be cited against that claim. Likewise, a narrower claim construction is generally more resilient against prior art (e.g., it is easier to argue that the cited prior art does not teach the narrower claim limitations) but may make it more difficult to assert that the accused product practices the narrower claim construction.

As such, many patent disputes hinge on the claim constructions, such as the parties' assessments as to whether a judicial body will adopt broader or narrower constructions of the claims.

This analysis of patent claims is resource- and time-intensive, and generally involves detailed analysis by specialized attorneys and experts, therefore resulting in high legal and expert fees for parties seeking to assert patents as well as for defendants seeking to identify non-infringement arguments and/or to invalidate those patents.

Accordingly, aspects of embodiments of the present disclosure relate to systems and methods for making the claim chart building process more efficient and less expensive by automatically generating claim charts for infringement (or non-infringement) and validity (or invalidity). Some aspects of embodiments of the present disclosure further relate to automatically generating claim constructions for the terms and limitations of the claims to generate claim charts consistent with those claim constructions. Further embodiments of the present disclosure relate to adjusting the claim constructions to be broader or narrower and automatically generating or regenerating the claim charts based on the updated claim constructions. Other embodiments of the present disclosure relate to adjusting the claim constructions to be broader or narrower and automatically generating or regenerating the claim charts based on the updated claim constructions to determine the best claim construction or claim constructions that provide the highest chance of infringement and lowest risk of invalidating the patent or, alternatively, determining the claim construction that provides the lowest chance of infringement and the highest risk of invalidating the patent.

In more detail, aspects of embodiments of the present disclosure relate to the use of language models including large language models (LLMs) and/or small language models (SLMs) in performing automatic analysis of text data as well as image data and video data and automatically generating the claim charts using the language models. Some aspects of embodiments further relate to applying retrieval augmented generation (RAG) to control the content of the generated claim charts, such as by presenting the language model with relevant sections of prior art references for generating a validity claim chart (e.g., to invalidate the patent based on a lack of novelty and/or a showing of obviousness and/or a lack of inventive step) or presenting the language model with relevant documentation regarding the accused product for generating an infringement claim chart.

This approach provides many technical advantages over comparable processes that would otherwise be performed manually by an attorney, technical expert or other professional working in the field of patent law. Language models can automatically process large amounts of data (e.g., thousands of technical papers) much more quickly than a human could otherwise do, thereby accelerating the screening of potential prior art references without merely relying on keyword searches of databases (e.g., Boolean searching of patent publications, academic journals, and/or online publications). In addition, language models can be used to automatically generate natural language text data and images in response to natural language prompts, which may include relevant context for the prompt. Therefore, some aspects of embodiments of the present disclosure relate to prompting language models to automatically generate claim charts, where the prompts include context for generating the claim charts, including the text of corresponding patents, prior art, and/or documentation regarding potentially infringing products, thereby also reducing the cost of producing claim charts compared to employing human experts to do so, and thereby allowing human experts to focus on other aspects of the negotiation process and/or to review the output generated by the language model.

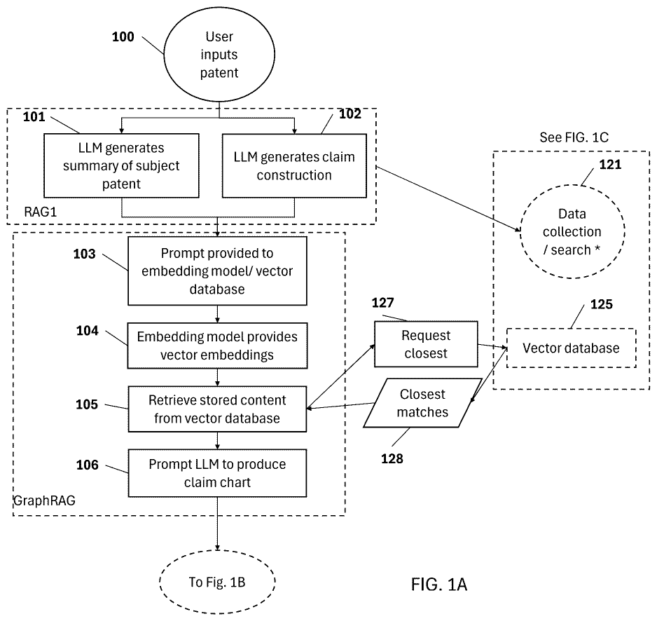

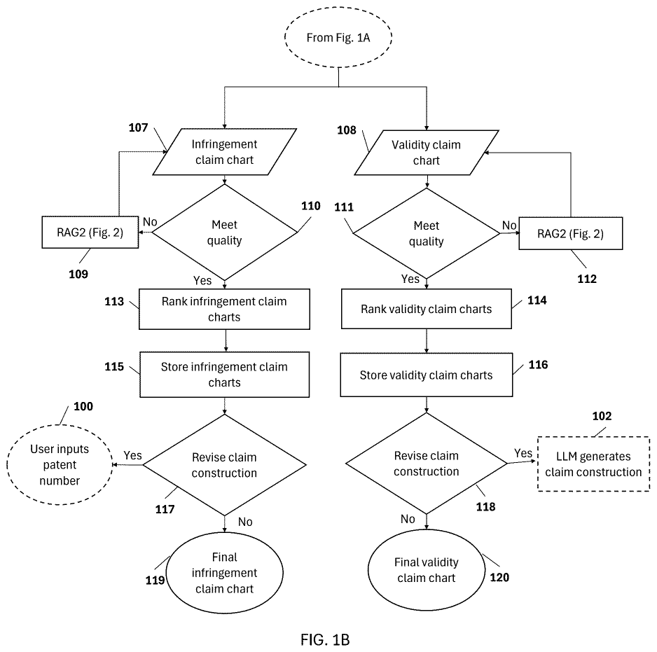

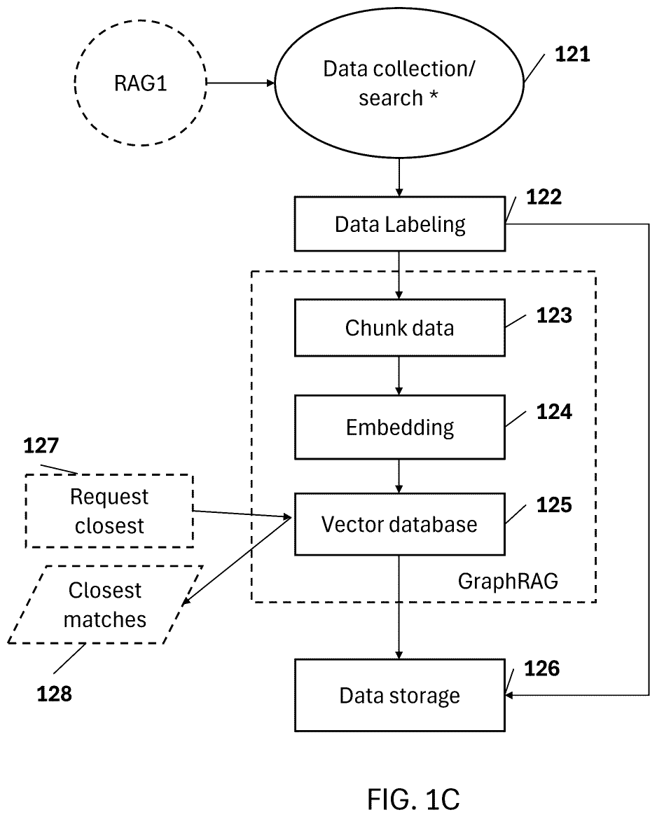

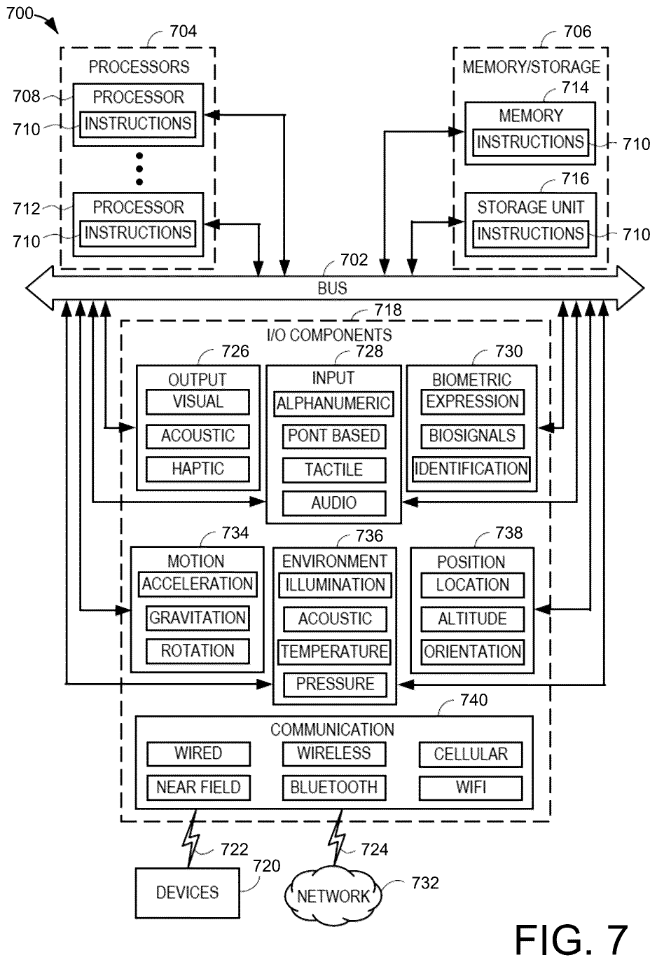

FIGS. 1A, 1B, and 1C depict a flowchart of a method for generating infringement or validity claim charts using a language model, according to one embodiment of the present disclosure. The method shown in FIGS. 1A, 1B, and 1C depict may be implemented by a computer system (such as the machine 700 described below with respect to FIG. 7) including one or more processing circuits and memory storing instructions that, when executed by the one or more processing circuits, configure the computer system to operate as a special-purpose machine for automatically generating claim charts, according to one embodiment of the present disclosure.

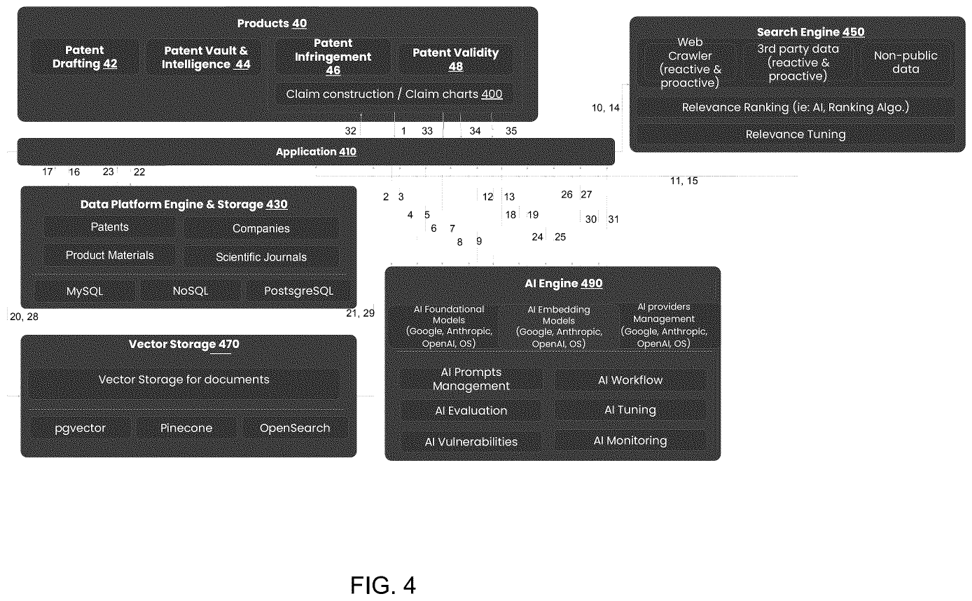

FIG. 4 is a block diagram of a system 400 for generating claim charts, according to one embodiment of the present disclosure. In some embodiments of the present disclosure, the system 400 is implemented by a computer system (such as the machine 700 described below with respect to FIG. 7) including one or more processing circuits and having instructions stored in one or more memories that, when executed by the one or more processing circuits, configure the computer system to implement a system for generating claim charts.

The system 400 for generating claim charts may be one component of an encompassing system 40 that provides additional functionality relating to the automatic analysis of patents, such as automatic patent drafting support functionality 42, patent vault and intelligence services 44, infringement detection analysis 46, and patent validity analysis 48. The claim charts generated by a system 400 according to embodiments of the present disclosure may be consumed or used by products including automatic infringement detection analysis 46 and patent validity analysis 48 functionality.

The functionality of the system 400 may be implemented in an application 410 which orchestrates interactions between various data, including the content (e.g., text and drawings) of a patent to be analyzed, previously-collected and analyzed data stored in a data platform engine 430, a search engine 450 for retrieving additional data, vector storage 470 (e.g., a vector database such as Pinecone® or OpenSearch®) for storing and retrieving documents in accordance with vector embeddings (e.g., representations of the semantic meanings of chunks of text), and an artificial intelligence (AI) engine 490 which includes one or more large language models (LLMs). Examples of LLMs include the GPT family of models from OpenAI®, the Llama® family of models from Meta®, the Claude family of models from Anthropic®, and the Gemini family of models from DeepMind®. The application 410 coordinates the supplying of inputs to the AI engine 490, receiving results from the AI engine 490, and supplying additional data to the AI engine 490 to produce claim charts for various purposes, including performing infringement analysis and validity analysis, as will be described in more detail below.

Referring to FIG. 1A, at 100, a user inputs a patent to be analyzed, such as by providing a patent number (e.g., a typically 7-digit or 8-digit number in the case of a United States patent, where other jurisdictions may have different formats for identifying patents), and the application in FIG. 4 at 410 retrieves the text and figures of the corresponding patent from a data store (e.g., a public data source or a local cache of patent documents such as within the data platform engine 430). In some embodiments, a user supplies the text and figures of a patent directly to the system, such as in a case where a user is analyzing a draft of a patent application to be filed.

At 101, the application 410 provides the patent (e.g., the text and figures of the patent) to a language model to generate a summary of the subject patent. At 102, the application 410 also supplies the claims to a language model to generate a claim construction. The terms and limitations of a claim are construed based on intrinsic evidence, that is, the text and figures of the patent application (referred to as the specification) and the prosecution history of the patent application (that is, the written communications between the patent applicant and the patent office that granted the patent). Arguments made by the patent applicant regarding the meaning of claim terms and limitations can further narrow the range of possible constructions. The language in patent claims is also generally interpreted based on how they would be understood by a person knowledgeable in the field (formally, in the United States, a person having ordinary skill in the art at the time of the invention).

Accordingly, at 102, the application 410 prompts an LLM to generate claim constructions for the terms of a set of claims based on associated documents such as the specification of the patent, prosecution data (e.g., the text of written communications between the applicant and the patent office), and, optionally, a dictionary (e.g., to provide definitions of terms as they would be generally understood), along with any additional user-uploaded materials (e.g., additional supplemental technical dictionaries specific to a field). In more detail, the application 410 supplies the associated documents to be labeled at 122 (e.g., by labeling the documents as being part of the specification, part of the prosecution file history, extrinsic evidence such as dictionaries, and the like), and then chunking the data at 123, such as by performing hierarchical chunking (e.g., based on existing section headings in the document) or semantic chunking (e.g., based on paragraphs or sentences in the document) or combinations thereof (e.g., hierarchical chunking with semantic chunking within the sections). At 124, the chunks are supplied to an embedding model (e.g., implemented using an LLM) to compute corresponding embeddings for each chunk.

In some embodiments, the claims are also chunked into separate terms or limitations (e.g., based on the semantics of the clauses) and, likewise, an embedding model (e.g., an LLM) may be used to compute embeddings for each of the terms or limitations of the claims. The embeddings are stored in a vector database, such as one from Pinecone®.

Accordingly, in some embodiments the application 410 may search the vector database for chunks of data (e.g., text and/or images) in the evidence (the specification, prosecution file history, dictionaries, and the like) for chunks of data that are the closest matches, e.g. semantically related, to each term or limitation of the claim and/or their constructions. These retrieved relevant chunks of data may be supplied to an LLM together with the claim term or limitation to be construed, where the LLM is prompted to generate a claim construction for that claim term, claim limitation, and/or claim construction based on the provided supporting evidence.

At 103, the summary of the subject patent and the claim constructions computed at 101 and 102 are provided as part of a prompt to an embedding model and to query a vector database of chunks of documents to retrieve, e.g. the closest matching, chunks that are relevant to generating a corresponding infringement claim chart or validity claim chart.

In more detail, the vector database may be populated with chunks of data in accordance with a process shown in FIG. 1C, starting at 121. In some embodiments of the present disclosure, the claim constructions and summary of the patent are used to direct the collection of the documents, such as performing searches (e.g. internet and data stores) at 121 using the search engine 450 where, as noted above, different types of documents are searched for and collected depending on whether the claim chart to be produced is an infringement claim chart or a validity claim chart. In the case of an infringement claim chart, searches may be performed to identify current products and processes that may infringe the patent (in some embodiments, the user may further identify specific targeted entities, such as names of corporations that are believed to practice the claims of the patent). In the case of a validity claim chart, the searches may be restricted to publications that would qualify as prior art under the specific rules of the jurisdiction (e.g., documents published prior to the priority date of the subject patent).

The search engine 450 may make calls to external internet search engines (e.g., by driving a web browser or through an application programming interface (API)), external or internal databases (e.g., collections of academic papers and patents), and the like to perform these searches.

The resulting data (e.g., documents including images and text) is then labeled at 122 based on extracting metadata such as data type (e.g., prior art versus patent specification versus file history), publication date (e.g., year of publication, or year, month, and date), type of source (e.g., patent versus academic paper versus textbook), source (e.g., a citation back to the source of the data), and timestamp (e.g., retrieval timestamp).

At 123, the retrieved data (documents) are chunked, such as by performing hierarchical chunking (e.g., based on existing section headings in the document) or semantic chunking (e.g., based on paragraphs or sentences in the document) or combinations thereof (e.g., hierarchical chunking with semantic chunking within the sections). A large language model may then be used to compute an embedding for each chunk of the data at 124, and the chunks are stored in a vector database 125 in accordance with their corresponding embeddings, which may be stored in data storage 126 (e.g., in a persistent data storage device) along with the labels generated at 122.

At 104, the embedding model provides a vector embedding for each claim term (or claim limitation) based on its construction (e.g., based on the text of the construction of the term alone or based on the combination of the text of the construction and the text of the claim term). At 105, these embeddings are used to retrieve stored content (chunks) from the vector database based on the embeddings.

In more detail, at 127 the application 410 requests the closest matches to the embeddings from the vector database. As noted above, in the case of generating an infringement claim chart, the search of the vector database is constrained to chunks extracted from documents relating to accused products or potentially infringing products, and, in the case of generating a validity claim chart, the search of the vector database is constrained to chunks extracted from documents that are prior art (e.g., having publication dates prior to the priority date of the patent). Accordingly, chunks having embeddings that are most similar (e.g., based on cosine distance) to the embeddings of the claim terms (based on their claim constructions) are retrieved. Intuitively, these correspond to chunks (e.g., sentences or paragraphs) of the retrieved documents that are most semantically similar to the construed claim terms.

At 106, the application 410 prompts an LLM to produce a claim chart based on the claim terms and the retrieved chunks of the relevant documents. In FIG. 1B, at 107, an infringement claim chart is generated and, at 108, a validity claim chart is generated. In some embodiments, both an infringement claim chart and a validity claim chart are generated concurrently (e.g., in parallel or in sequence or interleaved) based on a same claim construction computed at 102. At 110 and 111, the infringement claim chart and the validity claim chart, respectively, are displayed (e.g., to a user) or automatically analyzed (e.g., by a large language model) to determine whether it meets a quality standard.

In some embodiments, the quality standard relates to whether the chunks of the documents that are cited for each term or limitation in the claim chart are pertinent or relevant to the corresponding claim term and/or claim construction (e.g., whether the cited portion of the document clearly shows that an accused product practices or exhibits the claim term or limitation, or whether the cited portion of the prior art teaches the claim term or limitation). If not, then it is possible that an inappropriate or inapplicable collection of chunks of documents was retrieved for generating that portion of the claim chart.

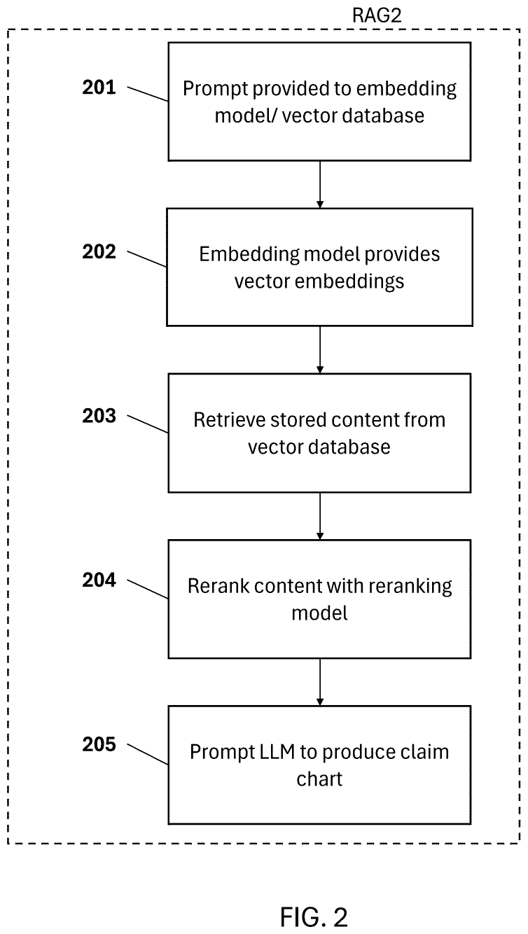

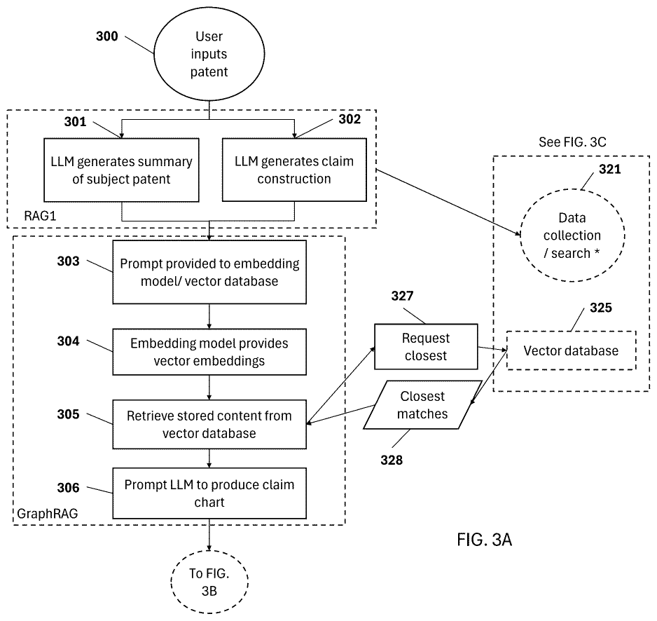

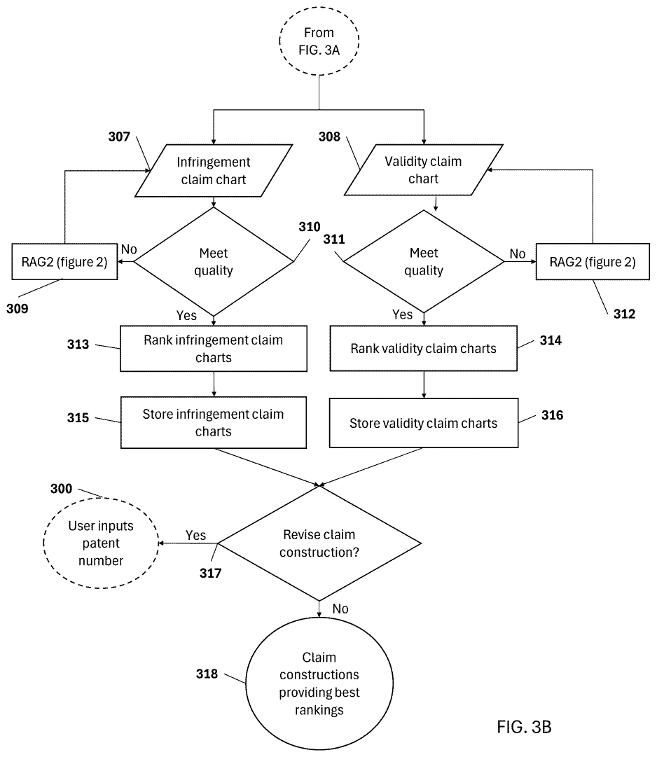

In circumstances where the generated claim chart does not meet the quality standard, then another or second phase of retrieval augmented generation is performed at 109 for an infringement claim chart or at 112 for a validity claim chart. The second phase retrieval augmented generation is described with respect to FIG. 2.

FIG. 2 is a flowchart of a method for regenerating a claim chart based on a reranking of retrieved content supplied to a language model, according to one embodiment of the present disclosure. The process of FIG. 2 is substantially similar to the process of prompting an LLM at 103, 104, 105, and 106 of FIG. 1A, as it includes providing a prompt to an embedding model/vector database at 201, generating vector embeddings using the embedding model at 202, and retrieving stored content from a vector database at 203. In the initial retrieval augmented generation process of FIG. 1A, the chunks retrieved from the vector database are provided to the LLM (as part of the prompt) in an order corresponding to the similarity (e.g., cosine distance) between the embedding of the claim term and the embeddings of the chunks. In contrast, during a second pass retrieval augmented generation as shown in FIG. 2, a reranking model (e.g., BGE reranker large) is used to re-rank the retrieved chunks, where the reranking model is trained to improve the quality of the output based on different criteria (e.g., not merely the similarity of the embeddings), as specified in a prompt to the reranking model. The reranked chunks are then used to generate a new prompt to produce a claim chart at 205, where the new claim chart is expected to differ from the prior claim chart due to the reranking.

A user may then review or rank the resulting infringement claim chart at 113 and/or validity claim chart at 114, which are stored at 115 and 116, respectively, and displayed in a user interface (e.g., implemented in a web browser or a standalone application) so that the user may determine if the claim construction needs to be revised. For example, a user working on behalf of a patent owner may be dissatisfied with an infringement claim chart that failed to show infringement (e.g., because one or more claim terms or limitations was not met by an accused product) and therefore may want to broaden the claim construction. As another example, the same user may be dissatisfied with a validity claim chart because the claim chart shows that all of the limitations are taught in the prior art and may therefore want the claim construction to be narrower. Similar analyses may apply for users working on behalf of accused infringers, who may want to adjust the claim constructions in the opposite directions.

Therefore, if the user is dissatisfied with the result, then they may seek to revise the claim construction (at 117 for an infringement claim chart or at 118 for a validity claim chart), such as by providing updated instructions to generate a broader claim construction or a narrower claim construction at 102. In some embodiments, the claim constructions can be broadened or narrowed on a per-claim term or per-claim limitation basis. In some embodiments, the user interface provides a slider control for broadening or narrowing a claim construction, where the user can “scrub” through different breadths of claim constructions and observe how these changes affect the infringement claim chart and/or the validity claim chart (e.g., causing terms or limitations to be found or not found in various accused products and/or causing terms or limitations to be taught or not taught based on the prior art).

In some embodiments, a syntax tree is used to broaden or narrow the construction of a claim term or limitation. For example, the term “processing device” may initially be construed as “A processing device may refer to nodes in the network such as clients, servers, workstations, switches, and routers.” The syntax tree for this construction may be represented in Table 1

TABLE 1
Processing device

|---- nodes in the network
| |---- clients
| |---- servers
| |---- workstations
| |---- switches
| |---- routers

Accordingly, adding leaf nodes or removing leaf nodes can broaden or narrow a claim construction, depending on whether the leaf nodes are conjunctive (e.g., “and”) or disjunctive (e.g., “or”). For example, “routers” and “switches” can be removed from the above syntax tree, as shown in Table 2, thereby broadening the scope of the construction because even a system that did not include routers and switches would still be a “processing device” (because the above claim construction uses the conjunctive “and”):

TABLE 2
Processing device

|---- nodes in the network
| |---- clients
| |---- servers
| |---- workstations

As another example, the scope could be narrowed by adding additional constraints (limitations) to the syntax tree regarding connections and number of nodes in the “processing device”:

TABLE 3
Processing device

|---- nodes in the network
| |---- clients
| |---- servers
| |---- workstations
| |---- switches
| |---- routers
| ---- connected with direct ethernet
| |---- fiber bandwidth
| ---- must have 10 nodes

In some embodiments, after performing the broadening or the narrowing operations, the LLM performs error checking to ensure that the updated interpretation is consistent with the detailed specification, prosecution history, dictionary definitions, and the like, such as by generating a claim chart showing support (intrinsic and extrinsic evidence) for the claim construction.

In some embodiments, the LLM further provides an indication as to the range of possible claim constructions for a specific term based on the amount of detail provided in defining a claim term within the patent and within the prosecution history (e.g., where terms that are left undefined in the patent and in the prosecution history are considered to be open to a wider range of possible constructions whereas claims that are tightly defined in the specification and/or in the prosecution history are considered to have a smaller range of possible constructions). The limits of the range of possible claim constructions may be computed based on whether evidentiary support can be found in the record (specification, prosecution history, dictionary definitions, claim constructions adopted by prior tribunals, such as a court or, for example, the PTAB, etc.) for the broadest construction and the narrowest construction, as well as intermediate constructions, as applicable. In some embodiments, a claim construction as adopted by a court or, for example, the PTAB, is used to specify an initial claim construction for generating the claim charts.

Referring to FIG. 1B, once the user is satisfied with the claim charts and the claim constructions, then the final infringement claim chart may be returned at 119 or the final validity claim chart may be returned at 120.

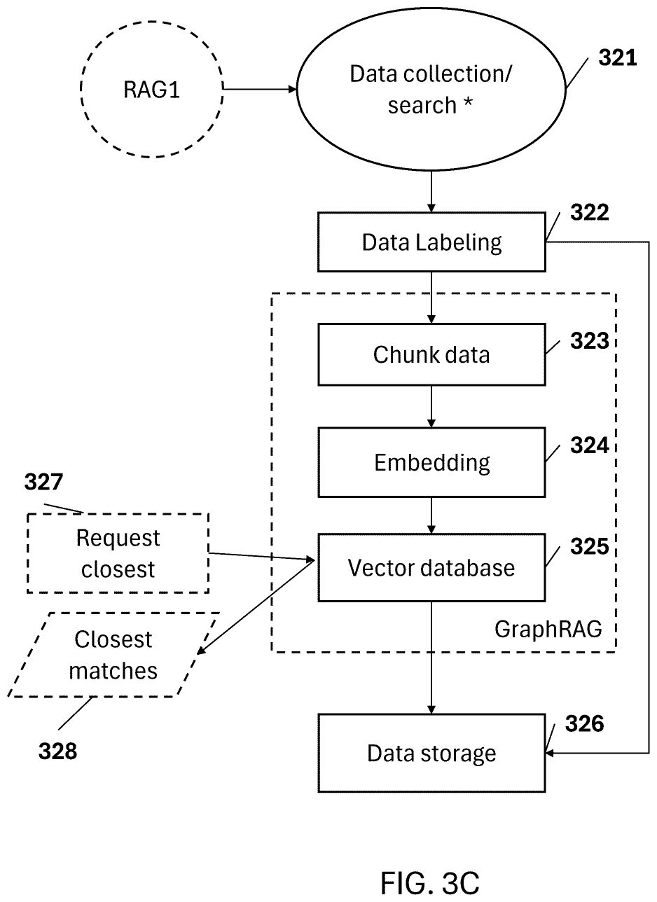

FIGS. 3A, 3B, and 3C depict a flowchart of a method for generating a claim construction that is jointly optimized based on an infringement analysis and a validity analysis, and generating associated infringement and validity claim charts, according to one embodiment of the present disclosure. The method shown in FIGS. 3A, 3B, and 3C is similar to the method shown in FIGS. 1A, 1B, and 1C and therefore descriptions of substantially similar portions will not be repeated below. The method of FIG. 3 differs from FIGS. 1A, 1B, and 1C in that the claim construction is jointly optimized or computed in accordance with both the infringement claim chart and the validity claim chart.

At 306 of FIG. 3A, the LLM (or multiple LLMs) is prompted to produce both an infringement claim chart at 307 and a validity (or invalidity) claim chart at 308. A similar process of determining whether the infringement claim chart meets quality standards at 310 and whether the validity claim chart meets quality standards at 311 is performed, along with subsequent iterations of performing the retrieval augmented analysis again based on a re-ranking of chunks at 309 and 312 (as shown in FIG. 2) is similar to that described above with respect to FIGS. 1A, 1B, and 1C.

At 313 and 314 the generated claim charts are evaluated (e.g., ranked) such as by retaining the quality standard score determined at 310 or 311, respectively, or based on a claim chart quality evaluation model (e.g., an LLM prompted to evaluate the claim chart and assign a numerical score). At 315 and 316, the infringement claim chart or validity claim chart is stored (e.g., in a persistent data store).

At 317, a user may then review the resulting infringement claim chart and validity claim chart together, which are displayed in a user interface, and determine if the claim construction needs to be revised. In some embodiments, the review of the infringement claim chart and the validity claim chart is performed automatically, such as by an LLM prompted to analyze whether each claim term or claim limitation in the claim chart reads on the corresponding citations (or chunks) provided in the claim chart.

For example, a patent owner may want to see that the infringement claim chart shows that an accused product or process infringes the patent and also want to see that the validity claim chart fails to invalidate the patent (e.g., that the patent appears to be valid in view of the prior art available). Conversely, a defendant may want to see an infringement claim chart that shows non-infringement of the claims (e.g., that the closest or best parts of the documentation show that the accused product is different from the claim terms) and/or that the validity claim chart shows that the subject patent is invalid. If so, then the user may provide additional guidance to regenerating the claim construction at 302, such as broadening or narrowing the construction of one or more terms or limitations to obtain an infringement claim chart and/or an validity claim chart that is better suited to their goals.

In another embodiment, at 317 the process automatically adjusts the claim constructions to be broader or narrower and automatically generating or regenerating the claim charts in accordance with the steps of FIGS. 3A, 3B, and 3C based on the updated claim constructions to determine the best claim construction or claim constructions that provide the highest chance of infringement and lowest risk of invalidating the patent (e.g., for a patent holder) or, alternatively, determining the claim construction or constructions that provides the lowest chance of infringement and the highest risk of invalidating the patent (e.g., for an alleged infringer). The patent holder and the alleged infringer may each want to see the best results for the other party and generate corresponding claim constructions accordingly.

When the user is satisfied with the resulting claim charts, then the generated claim constructions providing the best rankings or quality scores for the infringement and validity claim charts are output at 318 (e.g., displayed on a web page rendered by a web browser, exported as a standalone document in a file format associated with a word processor, and the like).

A user may use the method shown in FIGS. 3A, 3B, and 3C to identify likely positions taken by the opposing party. For example, a patent owner may want to explore likely claim construction positions taken by an accused infringer and can use the same method shown in FIGS. 3A, 3B, and 3C but drive the revision of the claim constructions to reach a goal of finding non-infringement and/or invalidity of the patent. Conversely, an accused infringer can explore likely claim constructions taken by a patent owner to reach conclusions of finding infringement and validity of the patent.

As such, embodiments of the present disclosure save significant amounts of manual analysis by using language models (e.g., large language models) to automatically analyze patent claims, automatically compute possible claim constructions based on the record (e.g., the specification, prosecution history, and extrinsic evidence), automatically compute possible infringement positions and invalidity positions, and the like.

As noted above, FIG. 4 is a block diagram of a system for generating claim charts, according to one embodiment of the present disclosure. FIG. 4 further includes arrows labeling communications between different components of the system.

One example of orchestration of data flows by the application 410 in one example embodiment of the present disclosure for infringement detection is described below:

[Label 1] Receiving an Infringement request. Web application sends a request to the Application backend with a subject patent ID.

[Label 2] Application calls the AI Engine to summarize the subject patent and to generate the claim constructions based on the detailed specification, dictionary, prosecution history data, and along with other user uploaded materials (if applicable) for the claim construction or claim interpretation.

[Label 3] AI Engine returns the summary and the claim construction of the patent back to the Application

[Label 4] Application calls the AI Engine with the patent summary and the claim construction to look for potentially infringing entities (e.g., companies)

[Label 5] AI Engine returns the potential infringing companies.

[Label 6] Application calls the AI Engine with the potential infringing companies to look for the potential infringing products from the companies.

[Label 7] AI Engine returns the potential infringing company products.

[Label 8] Application calls the AI Engine to generate the relevant search queries for the infringing products (e.g., products 1 . . . n)

[Label 9] AI Engine returns the relevant search queries for the infringing products (1 . . . n).

[Label 10] Application calls the Search Engine based on the relevant search queries and initiates the searches with the web crawler.

[Label 11] Search Engine returns top 30 results for each potential infringing product back to the Application

[Label 12] Application calls the AI Engine to rank the URLs

[Label 13] AI Engine returns the top 10 most relevant URLs.

[Label 14] Application calls the Search Engine to crawl the content from the top 10 URLs

[Label 15] Search Engine returns the crawled content back to the Application

(Label 10 to 15 repeat until the application exhausts all URLs from 2-level deep per URL, using Label 14 as the reference point)

[Label 16] Application calls the Data Platform Engine & Storage to persist the data.

[Label 17] Data Platform Engine & Storage returns the information needed for the steps required

[Label 18] Application calls the AI Engine to generate the vector embeddings using the embedding model for all the relevant product documents per product

[Label 19] AI Engine returns the vector embeddings per product document

[Label 20] Application persists the document vector embeddings to the vector storage

[Label 21] Vector storage returns the operation results back to the Application

[Label 22] Upon a request to generate an infringement claim chart for a potential infringing product, Application calls the Data Platform Engine & Storage to retrieve the patent detailed specs.

[Label 23] Data Platform Engine & Storage returns the patent detailed specification

[Label 24] Application calls the AI Engine to first generate a claim construction for the given patent with the claims selected by the users, else all the independent claims are used.

[Label 25] AI Engine returns the claim construction

[Label 26] Application then calls the AI Engine with the embedding model used to vectorize the documents and retrieve all the vector embeddings for the documents [Label 27] AI Engine returns the document embeddings

[Label 28] Application calls the vector storage to retrieve document chunks based on the embeddings for the given infringing product

[Label 29] Vector Storage returns all the relevant document chunks back to the Application

[Label 30] Application calls the AI Engine with the claim construction generated at Step 3 and all the relevant document chunks returned at Step 30

[Label 31] AI Engine returns the final claim chart result back to the Application

[Label 32] Application presents the final result in the web app

[Label 33] The user may then review and edit the claim construction interpretation for the claim terms and limitations.

[Label 34] Users can evoke the AI Engine to make recommendations based on the term iteration history provided by the users.

[Label 35] The user may also rerun the claim chart generation (Step 31) to evaluate the read strength.

The user repeats Step 34 and Step 35 until they are satisfied with the results.

The same system may be used to perform validity analysis (or invalidity analysis), according to one example embodiment, as described below:

[Label 1] Receiving a Validity request. Web application sends a request to the Application backend with a subject patent and the user uploaded prior art if any

[Label 2] Application calls the AI Engine to summarize the subject patent and to generate the claim constructions based on the detailed specification, dictionary, prosecution data, and along with the user uploaded materials for the claim interpretation.

[Label 3] AI Engine returns the summary and the claim constructions of the patent back to the Application

[Label 4] Application calls the Search Engine based on the system-generated claim constructions from Label 3 and the patent summary from Label 2 to look for the available prior art. The search involves searching through all the documents (curated+user uploaded) that are available for retrieval augmented generation (RAG)

[Label 16] Application calls the Data Platform Engine & Storage to persist the prior art documents discovered and the user uploaded prior art documents

[Label 17] Data Platform Engine & Storage returns the operation results back to the Application

[Label 18] Application calls the AI Engine to generate the vector embeddings using the embedding model for all prior art documents uploaded by the user and the prior art found from the search (closest matches found)

[Label 19] AI engine returns the vector embeddings for all the Prior Art documents back to the Application

[Label 20] Application persists the prior art vector embeddings to the vector storage

[Label 21] Vector Storage returns the operation results back to the Application

[Label 22] Upon a claim chart request for a potential Prior Art, Application calls the Data Platform Engine & Storage to retrieve the patent detailed specs.

[Label 23] Data Platform Engine & Storage returns the patent detailed specs

[Label 26] Application calls the AI Engine with the embedding modal used to vectorize the documents and retrieve all the vector embeddings for the documents

[Label 27] AI Engine returns the prior art document embeddings

[Label 28] Application calls the vector storage to retrieve document chunks based on the embeddings for all the uploaded documents

[Label 29] Vector storage returns all the relevant document chunks back to the Application

[Label 30] Application calls the AI Engine with the claim construction generated at Label 3 and all the relevant document chunks returned at Label 29

[Label 21] AI Engine returns the final claim chart result back to the Application

[Label 32] Application presents the final result in the web app

[Label 33] User reviews and edits the claim construction interpretation for the terms that are used to stake out the claim boundary. User can evoke AI Engine to make recommendations based on the term iteration history provided by the users.

[Label 34] User reruns the claim charts generation (Label 32) to evaluate the read strength

[Label 35] User repeats Step 33 and Step 34 until they are satisfied with the results.

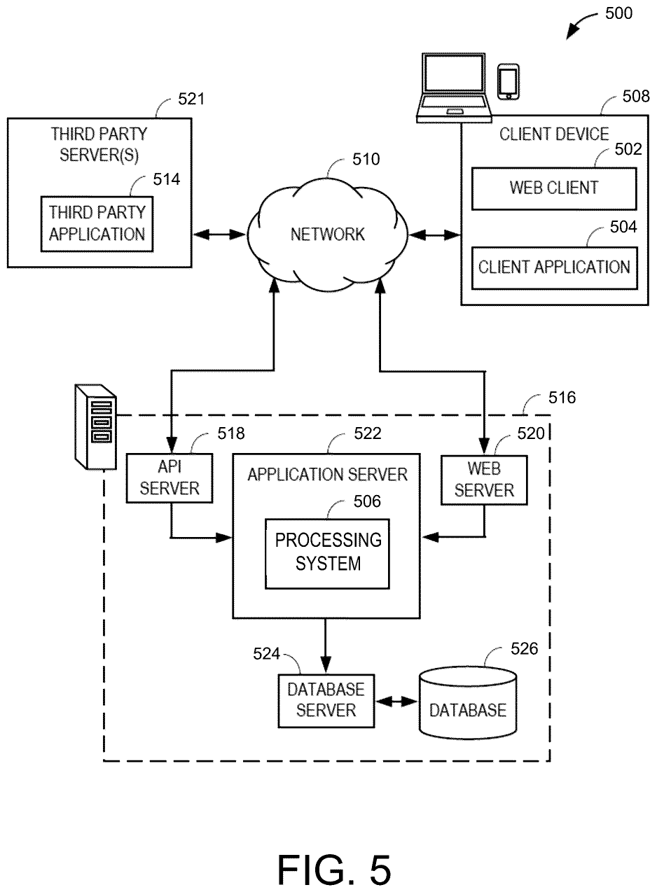

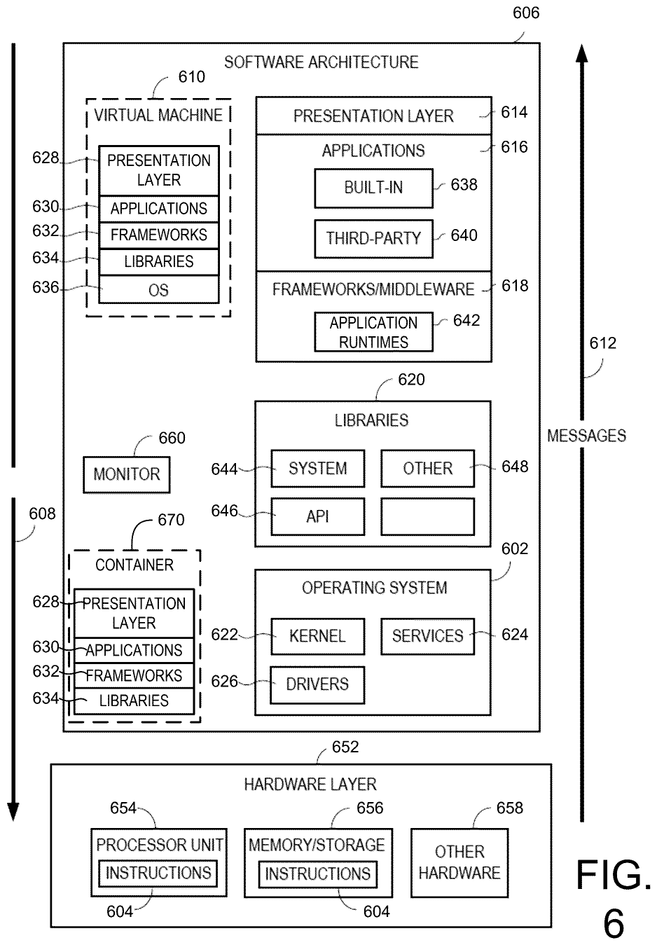

The system 400 implementing embodiments of the present disclosure such as those described above with respect to FIGS. 1A, 1B, and 1C, FIG. 2, and FIGS. 3A, 3B, and 3C may be executed on a computer system. The system shown in FIG. 4 may be implemented using a software architecture, as that described below with respect to FIG. 6 executed by one or more machines, such as machine 700 described below with respect to FIG. 7. The machine 700 may be a stand-alone machine (e.g., a personal computer such as a laptop computer) operated by the user or may be implemented on one or more server computers. The server computers may provide access to the system 400 using a software-as-a-service (SaaS) network architecture, as described below with respect to FIG. 5.

With reference to FIG. 5, an example embodiment of a high-level SaaS network architecture 500 is shown. A networked system 516 provides server-side functionality via a network 510 (e.g., the Internet or a WAN) to a client device 508. A web client 502 and a programmatic client, in the example form of a client application 504 (e.g., client software for accessing a system for generating claim charts), are hosted and execute on the client device 508. The networked system 516 includes one or more servers 522 (e.g., servers hosting services exposing remote procedure call APIs), which hosts a processing system 506 (such as the processing system described above according to various embodiments of the present disclosure supporting a service for generating claim charts) that provides a number of functions and services via a service oriented architecture (SOA) and that exposes services to the client application 504 that accesses the networked system 516 where the services may correspond to particular workflows. The client application 504 also provides a number of interfaces described herein, which can present an output in accordance with the methods described herein to a user of the client device 508.

The client device 508 enables a user to access and interact with the networked system 516 and, ultimately, the processing system 506. For instance, the user provides input (e.g., touch screen input or alphanumeric input) to the client device 508, and the input is communicated to the networked system 516 via the network 510. In this instance, the networked system 516, in response to receiving the input from the user, communicates information back to the client device 508 via the network 510 to be presented to the user.

An API server 518 and a web server 520 are coupled, and provide programmatic and web interfaces respectively, to the servers 522. For example, the API server 518 and the web server 520 may produce messages (e.g., RPC calls) in response to inputs received via the network, where the messages are supplied as input messages to workflows orchestrated by the processing system 506. The API server 518 and the web server 520 may also receive return values (return messages) from the processing system 506 and return results to calling parties (e.g., web clients 502 and client applications 504 running on client devices 508 and third-party applications 514) via the network 510. The servers 522 host the processing system 506, which includes components or applications in accordance with embodiments of the present disclosure as described above. The servers 522 are, in turn, shown to be coupled to one or more database servers 524 that facilitate access to information storage repositories (e.g., databases 526). In an example embodiment, the databases 526 includes storage devices that store information accessed and generated by the processing system 506 and the persistent store 580 of FIG. 5 and other databases such as databases storing documents that may be retrieved for supplementing the context provided to LLMs (e.g., based on retrieval augmented generation).

Additionally, a third-party application 514, executing on one or more third-party servers 521, is shown as having programmatic access to the networked system 516 via the programmatic interface provided by the API server 518. For example, the third-party application 514, using information retrieved from the networked system 516, may support one or more features or functions on a website hosted by a third-party. For example, the third-party application 514 may provide a cloud-based large language model (LLM). Turning now specifically to the applications hosted by the client device 508, the web client 502 may access the various systems (e.g., the processing system 506) via the web interface supported by the web server 520. Similarly, the client application 504 (e.g., an “app” such as an) may access the various services and functions provided by the processing system 506 via the programmatic interface provided by the API server 518. The client application 504 may be, for example, an “app” executing on the client device 508, such as an iOS or Android OS application to enable a user to access and input data on the networked system 516 in an offline manner and to perform batch-mode communications between the client application 504 and the networked system 516.

Further, while the network architecture 500 shown in FIG. 5 employs a client-server architecture, the present disclosure is not limited to such an architecture, and could equally well find application in a distributed, or peer-to-peer, architecture system, for example.

FIG. 6 is a block diagram illustrating an example software architecture 606, which may be used in conjunction with various hardware architectures herein described. FIG. 6 is a non-limiting example of a software architecture 606, and it will be appreciated that many other architectures may be implemented to facilitate the functionality described herein. The software architecture 606 may execute on hardware such as a machine 700 of FIG. 7 that includes, among other things, processors 704, memory/storage 706, and input/output (I/O) components 718. A representative hardware layer 652 is illustrated and can represent, for example, the machine 700 of FIG. 7. The representative hardware layer 652 includes a processor 654 having associated executable instructions 604. The executable instructions 604 represent the executable instructions of the software architecture 606, including implementation of the methods, components, and so forth described herein. The hardware layer 652 also includes non-transitory memory and/or storage modules as memory/storage 656, which also have the executable instructions 604. The hardware layer 652 may also include other hardware 658.

In the example architecture of FIG. 6, the software architecture 606 may be conceptualized as a stack of layers where each layer provides particular functionality. For example, the software architecture 606 may include layers such as an operating system 602, libraries 620, frameworks/middleware 618, applications 616 (such as the services of the processing system), and a presentation layer 614. Operationally, the applications 616 and/or other components within the layers may invoke API calls 608 through the software stack and receive a response as messages 612 in response to the API calls 608. The layers illustrated are representative in nature, and not all software architectures have all layers. For example, some mobile or special-purpose operating systems may not provide a frameworks/middleware 618, while others may provide such a layer. Other software architectures may include additional or different layers.

The operating system 602 may manage hardware resources and provide common services. The operating system 602 may include, for example, a kernel 622, services 624, and drivers 626. The kernel 622 may act as an abstraction layer between the hardware and the other software layers. For example, the kernel 622 may be responsible for memory management, processor management (e.g., scheduling), component management, networking, security settings, and so on. The services 624 may provide other common services for the other software layers. The drivers 626 are responsible for controlling or interfacing with the underlying hardware. For instance, the drivers 626 include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 620 provide a common infrastructure that is used by the applications 616 and/or other components and/or layers. The libraries 620 provide functionality that allows other software components to perform tasks in an easier fashion than by interfacing directly with the underlying operating system 602 functionality (e.g., kernel 622, services 624, and/or drivers 626). The libraries 620 may include system libraries 644 (e.g., C standard library) that may provide functions such as memory allocation functions, string manipulation functions, mathematical functions, and the like. In addition, the libraries 620 may include API libraries 646 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), and the like. The libraries 620 may also include a wide variety of other libraries 648 to provide many other APIs to the applications 616 and other software components/modules.

The frameworks/middleware 618 provide a higher-level common infrastructure that may be used by the applications 616 and/or other software components/modules. For example, the frameworks/middleware 618 may provide high-level resource management functions, web application frameworks, application runtimes 642 (e.g., a Java virtual machine or JVM), and so forth. The frameworks/middleware 618 may provide a broad spectrum of other APIs that may be utilized by the applications 616 and/or other software components/modules, some of which may be specific to a particular operating system or platform.

The applications 616 include built-in applications 638 and/or third-party applications 640. The applications 616 may use built-in operating system functions (e.g., kernel 622, services 624, and/or drivers 626), libraries 620, and frameworks/middleware 618 to create user interfaces to interact with users of the system. Alternatively, or additionally, in some systems, interactions with a user may occur through a presentation layer, such as the presentation layer 614. In these systems, the application/component “logic” can be separated from the aspects of the application/component that interact with a user.

Some software architectures use virtual machines. In the example of FIG. 6, this is illustrated by a virtual machine 610. The virtual machine 610 creates a software environment where applications/components can execute as if they were executing on a hardware machine (such as the machine 700 of FIG. 7, for example). The virtual machine 610 is hosted by a host operating system (e.g., the operating system 602 in FIG. 6) and typically, although not always, has a virtual machine monitor 660 (or hypervisor), which manages the operation of the virtual machine 610 as well as the interface with the host operating system (e.g., the operating system 602). A software architecture executes within the virtual machine 610 such as an operating system (OS) 636, libraries 634, frameworks 632, applications 630, and/or a presentation layer 628. These layers of software architecture executing within the virtual machine 610 can be the same as corresponding layers previously described or may be different.

Some software architectures use containers 670 or containerization to isolate applications. The phrase “container image” refers to a software package (e.g., a static image) that includes configuration information for deploying an application, along with dependencies such as software components, frameworks, or libraries that are required for deploying and executing the application. As discussed herein, the term “container” refers to an instance of a container image, and an application executes within an execution environment provided by the container. Further, multiple instances of an application can be deployed from the same container image (e.g., where each application instance executes within its own container). Additionally, as referred to herein, the term “pod” refers to a set of containers that accesses shared resources (e.g., network, storage), and one or more pods can be executed by a given computing node. A container 670 is similar to a virtual machine in that it includes a software architecture including libraries 634, frameworks 632, applications 630, and/or a presentation layer 628, but omits an operating system and, instead, communicates with the underlying host operating system 602.

FIG. 7 is a block diagram illustrating components of a machine 700, according to some example embodiments, able to read instructions from a non-transitory machine-readable medium (e.g., a computer-readable storage medium) and perform any one or more of the methodologies discussed herein. Specifically, FIG. 7 shows a diagrammatic representation of the machine 700 in the example form of a computer system, within which instructions 710 (e.g., software, a program, an application, an applet, an app, or other executable code) for causing the machine 700 to perform any one or more of the methodologies discussed herein may be executed. As such, the instructions 710 may be used to implement modules or components described herein. The instructions 710 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may include, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), other smart devices, a web appliance, a network router, a network switch, a network bridge, or any machine capable of executing the instructions 710, sequentially or in parallel or concurrently, that specify actions to be taken by the machine 700. Further, while only a single machine 700 is illustrated, the term “machine” or “processing circuit” shall also be taken to include a collection of machines that individually or jointly execute the instructions 710 to perform any one or more of the methodologies discussed herein.

The machine 700 may include processors 704 (including processors 708 and 712), memory/storage 706, and I/O components 718, which may be configured to communicate with each other such as via a bus 702. The memory/storage 706 may include a memory 714, such as a main memory, or other memory storage, and a storage unit 716, both accessible to the processors 704 such as via the bus 702. The storage unit 716 and memory 714 store the instructions 710 embodying any one or more of the methodologies or functions described herein. The instructions 710 may also reside, completely or partially, within the memory 714, within the storage unit 716, within at least one of the processors 704 (e.g., within the processor's cache memory), or any suitable combination thereof, during execution thereof by the machine 700. Accordingly, the memory 714, the storage unit 716, and the memory of the processors 704 are examples of machine-readable media.

The I/O components 718 may include a wide variety of components to receive input, provide output, produce output, transmit information, exchange information, capture measurements, and so on. The specific I/O components 718 that are included in a particular machine will depend on the type of machine. For example, portable machines such as mobile phones may include a touch input device or other such input mechanisms, while a headless server machine will likely not include such a touch input device. It will be appreciated that the I/O components 718 may include many other components that are not shown in FIG. 7. The I/O components 718 are grouped according to functionality merely for simplifying the following discussion, and the grouping is in no way limiting. In various example embodiments, the I/O components 718 may include output components 726 and input components 728. The output components 726 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 728 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and/or force of touches or touch gestures, or other tactile input components), audio input components (e.g., a microphone), and the like.

In further example embodiments, the I/O components 718 may include biometric components 730, motion components 734, environment components 736, or position components 738, among a wide array of other components. For example, the biometric components 730 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 734 may include acceleration sensor components (e.g., accelerometer), gravitation sensor components, rotation sensor components (e.g., gyroscope), and so forth. The environment components 736 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas sensors to detect concentrations of hazardous gases for safety or to measure pollutants in the atmosphere), or other components that may provide indications, measurements, or signals corresponding to a surrounding physical environment. The position components 438 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 718 may include communication components 740 operable to couple the machine 700 to a network 732 or devices 720 via a coupling 724 and a coupling 722, respectively. For example, the communication components 740 may include a network interface component or other suitable device to interface with the network 732. In further examples, the communication components 740 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 720 may be another machine or any of a wide variety of peripheral devices (e.g., a peripheral device coupled via a USB).

Moreover, the communication components 740 may detect identifiers or include components operable to detect identifiers. For example, the communication components 740 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 740, such as location via Internet Protocol (IP) geo-location, location via Wi-Fi® signal triangulation, location via detecting an NFC beacon signal that may indicate a particular location, and so forth.

The term non-transitory computer-readable medium is to be understood herein to refer to one or more non-transitory computer-readable media, such as a single solid-state drive, multiple solid-state drives connected in a redundant array of independent drives, one or more hard disk drives (e.g., magnetic data storage media), one or more optical (e.g., CD-ROM or DVD-ROM) media, one or more pools of data storage devices connected to one or more computer servers, and the like.

It should be understood that the sequence of steps of the processes described herein in regard to various methods and with respect various flowcharts is not fixed, but can be modified, changed in order, performed differently, performed sequentially, concurrently, or simultaneously, or altered into any desired order consistent with dependencies between steps of the processes, as recognized by a person of skill in the art. Further, as used herein and in the claims, the phrase “at least one of element A, element B, or element C” is intended to convey any of: element A, element B, element C, elements A and B, elements A and C, elements B and C, and elements A, B, and C.

A person of ordinary skill in the art would appreciate, in view of the present disclosure in its entirety, that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner.

According to one embodiment of the present disclosure, a method for orchestrating use of a language model to generate a claim chart for a patent includes: retrieving the patent and a file history of the patent and storing the patent and the file history in a data storage, collecting documentation relating to the patent, data labeling the documentation and storing the documentation in the data storage, chunking the documentation, for each chunk of documentation, creating a vector embedding, and storing the vector embeddings and related chunks in a vector data structure, generating, with the language model, a first version of claim constructions of the patent and a summary of the patent using the patent and the file history, creating a vector embedding for each limitation of the first version of the claim constructions, for each vector embedding of the first version of the claim constructions and the vector embeddings stored in the vector data structure, identifying the vector embeddings having the closest matches, retrieving, from the vector data structure, the chunks of documentation associated with the vector embeddings having the closest matches, providing the language model the first version of the claim constructions and the chunks of documentation associated with the closet matches, and using the language model to generate a claim chart including the first version of the claim constructions and the chunks of documentation associated with the closet matches.

The method may further include generating an infringement claim chart wherein the documentation associated with the vector embeddings having the closest matches is product documentation of infringing products.

The method may further include generating a validity claim chart wherein the documentation associated with the vector embeddings having the closest matches is prior art documentation.

The method may further include: generating a second version of the claim constructions, creating a vector embedding for each limitation of the second version of the claim constructions, for each vector embedding of the second version of the claim constructions and the vector embeddings stored in the vector data structure, identifying the vector embeddings having the closest matches, retrieving from the vector data structure the chunks of documentation associated with the vector embeddings having the closest matches, providing the language model the second version of the claim constructions and the chunks of documentation associated with the closet matches, and using the language model to generate a claim chart including the second version of the claim constructions and the chunks of documentation associated with the closet matches.

The second version of the claim constructions may be narrower than the first version of the claim constructions.

The second version of the claim constructions may be broader than the first version of the claim constructions.

The method may further include generating a plurality of versions of the claim constructions, wherein the plurality of versions of the claim constructions are broader or narrower than the first version.

The method may further include: embedding the plurality of versions of the claim constructions; and storing the embeddings of the plurality of versions of the claim constructions in the vector data structure.

The method may further include using a graph, tree or table structure for storing in the vector database the embeddings of the plurality of versions of the claim constructions.

The method may further include ranking the chunks of documentation.

The method may further include using one or more assessment strategies to rank the chunks of documentation.

The method may further include using one or more of faithfulness, answer relevance or context relevance.

The method may further include using one or more RAGAs strategies to rank the chunks and generating the infringement claim chart, using the language model, wherein the infringing products are ranked according to infringement likelihood.

The method may further include using one or more RAGAs strategies to rank the chunks and generating the validity claim chart wherein prior art documentation is ranked according to invalidity likelihood.

The method may further include: crawling the internet for documentation using a broader or a narrower version of the claim constructions stored in the vector data structure and a summary of the patent, chunking the documentation and storing the chunks of documentation in the vector data structure, for each chunk of documentation, creating a vector embedding, and storing the vector embedding in the vector data structure, creating a vector embedding for each limitation of the broader or the narrower version of the claim constructions, retrieving from the vector data structure the chunks of documentation associated with the vector embeddings having the closest matches, for each vector embedding of the broader or the narrower version of the claim constructions and the vector embeddings stored in the vector data structure, identifying the vector embeddings having the closest matches, and providing to the language model the broader or the narrower version of the claim constructions and the chunks of documentation associated with the vector embeddings of the closet matches, and generating the claim chart including the broader of narrower version of the claim constructions and the chunks of documentation associated with the closet matches.

The step of storing the plurality of versions of the claim constructions in a second data structure may include storing the plurality of versions of the claim constructions in a tree, graph or table data structure.

The method may further include generating an infringement claim chart wherein the documentation associated with the vector embeddings having the closest matches is product documentation of infringing products.

The method may further include generating a validity claim chart wherein the documentation associated with the vector embeddings having the closest matches is prior art documentation.

According to one embodiment of the present disclosure, a method for orchestrating use of a language model to generate an infringement claim chart for a patent on one or more infringing products includes: providing the patent and a file history of the patent to the language model, generating a first version the claim constructions of the patent and a summary of the patent with the language model using the patent and the file history, creating a vector embedding for each limitation of the first version of the claim constructions, crawling the internet for documentation on one or more infringing products using the first version of the claim constructions and the summary of the patent, chunking the documentation for the one or more infringing products and storing the chunks of documentation in a vector data structure, for each chunk of documentation, creating a vector embedding, and storing the vector embedding in the vector data structure, for each vector embedding of the first version of the claim constructions and the vector embeddings stored in the vector data structure, identifying the vector embeddings having the closest matches, retrieving from the vector data structure the chunks of documentation associated with the vector embeddings having the closest matches, providing the language model the first version of the claim constructions and the chunks of documentation associated with the closet matches, and using the language model to generate the infringement claim chart including the first version of the claim constructions and the chunks of documentation associated with the closet matches.

The method may further include: generating a plurality of the claim constructions that are narrower than the first version, generating a plurality of the claim constructions that are broader than the first version, and storing in a second data structure the plurality of versions of the claim constructions so that each of the versions is retrievable.

The method may further include: crawling the internet for documentation for one or more infringing products using a broader or a narrower version of the claim constructions stored in the second data structure and a summary of the patent, chunking the documentation for the one or more infringing products and storing the chunks of documentation in the vector data structure, for each chunk of documentation, creating a vector embedding, and storing the vector embedding in the vector data structure, creating a vector embedding for each limitation of the broader or the narrower version of the claim constructions, retrieving from the vector data structure the chunks of documentation associated with the vector embeddings having the closest matches, for each vector embedding of the broader or the narrower version of the claim constructions and the vector embeddings stored in the vector data structure, identifying the vector embeddings having the closest matches, providing to the language model the broader or the narrower version of the claim constructions and the chunks of documentation associated with the vector embeddings of the closet matches, and generating the infringement claim chart with the broader or narrower version of the claim constructions and the chunks of documentation associated with the closet matches.

The step of storing the plurality of versions of the claim constructions in a vector data structure may include storing the plurality of versions of the claim constructions in a graph, tree or table data structure.

According to one embodiment of the present disclosure, a method for orchestrating use of a language model to generate a validity claim chart for a patent with one or more prior art references includes: providing the patent and a file history of the patent to the language model, generating a first version of claim constructions of the patent and a summary of the patent with the language model using the patent and the file history, creating a vector embedding for each limitation of the first version of the claim constructions, crawling the internet for documentation on one or more prior art references using the first version of the claim constructions and the summary of the patent, chunking the documentation for the one or more prior art references and storing the chunks of documentation in a vector data structure, for each chunk of documentation, creating a vector embedding, and storing the vector embeddings in the vector data structure, for each vector embedding of the first version of the claim constructions and the vector embeddings stored in the vector data structure, identifying the vector embeddings having the closest matches, retrieving from the vector data structure the chunks of documentation associated with the vector embeddings having the closest matches, providing the language model the first version of the claim constructions and the chunks of documentation associated with the closet matches, and using the language model to generate the validity claim chart including the first version of the claim constructions and the chunks of documentation associated with the closet matches.

The method may further include: generating a plurality of the claim constructions that are narrower than the first version, generating a plurality of the claim constructions that are broader than the first version, and storing in a second data structure the plurality of versions of the claim constructions so that each of the versions is retrievable.

The method may further include: crawling the internet for documentation for one or more prior art references using a broader or a narrower version of the claim constructions stored in the second data structure and a summary of the patent, chunking the documentation for one or more infringing products and storing the chunks of documentation in the vector data structure, for each chunk of documentation, creating a vector embedding, and storing the vector embedding in the vector data structure, creating a vector embedding for each limitation of the broader or the narrower version of the claim constructions, retrieving from the vector data structure the chunks of documentation associated with the vector embeddings having the closest matches, for each vector embedding of the broader or the narrower version of the claim constructions and the vector embeddings stored in the vector data structure, identifying the vector embeddings having the closest matches, providing to the language model the broader or the narrower version of the claim constructions and the chunks of documentation associated with the vector embeddings of the closet matches, and generating the validity claim chart including the broader or the narrower version of the claim constructions and the chunks of documentation associated with the closet matches.

The step of storing the plurality of versions of the claim constructions in a second data structure may include storing the plurality of versions of the claim constructions in a tree, graph or table data structure.

According to one embodiment of the present disclosure, a method for orchestrating use of a language model to generate a claim construction that is optimized for the highest probability of infringement and lowest probability of invalidating a patent includes: providing the patent and a file history of the patent to the language model, generating a first version the claim constructions of the patent and a summary of the patent with the language model using the patent and the file historycreating a vector embedding for each limitation of a first version of the claim constructions, crawling for documentation on one or more prior art references using the first version of the claim constructions and the summary of the patent, crawling for documentation on one or more infringing products using the first version of the claim constructions and the summary of the patent, chunking the documentation and storing the chunks of documentation in a vector data structure, for each chunk of documentation, creating a vector embedding, and storing the vector embeddings in the vector data structure, for each vector embedding of the first version of the claim constructions and the vector embeddings stored in the vector data structure, identifying the vector embeddings having the closest matches, retrieving from the vector data structure the chunks of documentation associated with the vector embeddings having the closest matches, providing the language model the first version of the claim constructions and the chunks of documentation associated with the closet matches, and using the language model to generate a first version of a validity claim chart and an second version of an infringement chart including the first version of the claim constructions and the chunks of documentation associated with the closet matches, generating a plurality of the claim constructions that are narrower than the first version, generating a plurality of the claim constructions that are broader than the first version, storing in a second data structure the plurality of versions of the claim constructions so that each of the versions is retrievable, crawling for documentation for one or more prior art references using a broader or a narrower version of the claim constructions stored in the second data structure and a summary of the patent, crawling for documentation for one or more prior art references using a broader or a narrower version of the claim constructions stored in the second data structure and a summary of the patent, chunking the documentation for the one or more infringing products and storing the chunks of documentation in the vector data structure, for each chunk of documentation, creating a vector embedding, and storing the vector embedding in the vector data structure, creating a vector embedding for each limitation of the broader or the narrower version of the claim constructions, retrieving from the vector data structure the chunks of documentation associated with the vector embeddings having the closest matches, for each vector embedding of the broader or the narrower version of the claim constructions and the vector embeddings stored in the vector data structure, identifying the vector embeddings having the closest matches, and providing to the language model the broader or the narrower version of the claim constructions and the chunks of documentation associated with the vector embeddings of the closet matches, generating a second version of the validity claim chart and a second version of the infringement chart including the broader or the narrower version of the claim constructions and the chunks of documentation associated with the closet matches, determining the patent claim construction that provides the highest probability of infringement and lowest probability of invalidating a patent.

The step of storing the plurality of versions of the claim constructions in a second data structure may include storing the plurality of versions of the claim constructions in a tree, graph or table data structure.

The method may further include ranking the patent claim constructions in order of the highest probability of infringement and lowest probability of invalidating the patent and storing each of the versions of the infringement claim charts and validity claim charts in a second data structure.

According to one embodiment of the present disclosure, a method for orchestrating use of a language model to generate a claim construction that is optimized for lowest probability of infringement and highest probability of invalidating a patent includes: providing the patent and a file history of the patent to the language model, generating a first version of claim constructions of the patent and a summary of the patent with the language model using the patent and the file history, creating a vector embedding for each limitation of a first version of the claim constructions, crawling for documentation on one or more prior art references using the first version of the claim constructions and the summary of the patent, crawling for documentation on one or more infringing products using the first version of the claim constructions and the summary of the patent, chunking the documentation and storing the chunks of documentation in a vector data structure, for each chunk of documentation, creating a vector embedding, and storing the vector embeddings in the vector data structure, for each vector embedding of the first version of the claim constructions and the vector embeddings stored in the vector data structure, identifying the vector embeddings having the closest matches, retrieving from the vector data structure the chunks of documentation associated with the vector embeddings having the closest matches, providing the language model the first version of the claim constructions and the chunks of documentation associated with the closet matches, using the language model to generate a first version of a validity claim chart and an second version of an infringement chart including the first version of the claim constructions and the chunks of documentation associated with the closet matches, generating a plurality of the claim constructions that are narrower than the first version, generating a plurality of the claim constructions that are broader than the first version, storing in a second data structure the plurality of versions of the claim constructions so that each of the versions is retrievable, crawling for documentation for one or more prior art references using a broader or a narrower version of the claim constructions stored in the second data structure and a summary of the patent, crawling for documentation for one or more prior art references using a broader or a narrower version of the claim constructions stored in the second data structure and a summary of the patent, chunking the documentation for the one or more infringing products and storing the chunks of documentation in the vector data structure, for each chunk of documentation, creating a vector embedding, and storing the vector embedding in the vector data structure, creating a vector embedding for each limitation of the broader or the narrower version of the claim constructions, retrieving from the vector data structure the chunks of documentation associated with the vector embeddings having the closest matches, for each vector embedding of the broader or the narrower version of the claim constructions and the vector embeddings stored in the vector data structure, identifying the vector embeddings having the closest matches, providing to the language model the broader or the narrower version of the claim constructions and the chunks of documentation associated with the vector embeddings of the closet matches, generating a second version of the validity claim chart and a second version of the infringement chart including the broader or the narrower version of the claim constructions and the chunks of documentation associated with the closet matches, and determining the patent claim construction that provides the lowest probability of infringement and highest probability of invalidating a patent.

The step of storing the plurality of versions of the claim constructions in a second data structure may include storing the plurality of versions of the claim constructions in a tree, graph or table data structure.

The method may further include ranking the patent claim constructions in order of the lowest probability of infringement and highest probability of invalidating the patent and storing each of the versions of the infringement claim charts and validity claim charts in a second data structure.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

1. A method for orchestrating use of a language model to generate a claim chart for a patent comprising:
retrieving the patent and a file history of the patent and storing the patent and the file history in a data storage,
collecting documentation relating to the patent, data labeling the documentation and storing the documentation in the data storage,
chunking the documentation to generate chunks of documentation comprising content obtained from corresponding portions of the documentation,
for each chunk of documentation, creating a vector embedding, and storing the vector embeddings and related chunks in a vector data structure,
generating a first version of claim constructions of the patent and a summary of the patent by supplying a prompt comprising the patent and the file history to the language model,
creating a vector embedding for each limitation of the first version of the claim constructions,
for each vector embedding of the first version of the claim constructions and the vector embeddings stored in the vector data structure, identifying the vector embeddings having the closest matches,
retrieving, from the vector data structure, the chunks of documentation associated with the vector embeddings having the closest matches,
providing the language model the first version of the claim constructions and the chunks of documentation associated with the closet matches, and
using the language model to generate a claim chart comprising the first version of the claim constructions and the chunks of documentation associated with the closet matches.

2. The method of claim 1 further comprising generating an infringement claim chart wherein the documentation associated with the vector embeddings having the closest matches is product documentation of infringing products.

3. The method of claim 1 further comprising generating a validity claim chart wherein the documentation associated with the vector embeddings having the closest matches is prior art documentation.

4. The method of claim 1 further comprising:
generating a second version of the claim constructions,
creating a vector embedding for each limitation of the second version of the claim constructions,
for each vector embedding of the second version of the claim constructions and the vector embeddings stored in the vector data structure, identifying the vector embeddings having the closest matches,
retrieving from the vector data structure the chunks of documentation associated with the vector embeddings having the closest matches,
providing the language model the second version of the claim constructions and the chunks of documentation associated with the closet matches, and
using the language model to generate a claim chart comprising the second version of the claim constructions and the chunks of documentation associated with the closet matches.

5. The method of claim 4 wherein the second version of the claim constructions is narrower than the first version of the claim constructions.

6. The method of claim 4 wherein the second version of the claim constructions is broader than the first version of the claim constructions.

7. The method of claim 1 further comprising generating a plurality of versions of the claim constructions, wherein the plurality of versions of the claim constructions are broader or narrower than the first version.

8. The method of claim 7 further comprising: embedding the plurality of versions of the claim constructions; and
storing the embeddings of the plurality of versions of the claim constructions in the vector data structure.

9. The method of claim 8 further comprising using a graph, tree or table structure for storing in the vector database the embeddings of the plurality of versions of the claim constructions.

10. The method of claim 1 further comprising ranking the chunks of documentation.

11. The method of claim 10 further comprising using one or more assessment strategies to rank the chunks of documentation.

12. The method of claim 11 further comprising using one or more of faithfulness, answer relevance or context relevance.

13. The method of claim 2 further comprising using one or more RAGAs strategies to rank the chunks and generating the infringement claim chart, using the language model, wherein the infringing products are ranked according to infringement likelihood.

14. The method of claim 3 further comprising using one or more RAGAs strategies to rank the chunks and generating the validity claim chart wherein prior art documentation is ranked according to invalidity likelihood.

15. The method of claim 7 further comprising:
crawling the internet for documentation using a broader or a narrower version of the claim constructions stored in the vector data structure and a summary of the patent,
chunking the documentation and storing the chunks of documentation in the vector data structure,
for each chunk of documentation, creating a vector embedding, and storing the vector embedding in the vector data structure,
creating a vector embedding for each limitation of the broader or the narrower version of the claim constructions,
retrieving from the vector data structure the chunks of documentation associated with the vector embeddings having the closest matches,
for each vector embedding of the broader or the narrower version of the claim constructions and the vector embeddings stored in the vector data structure, identifying the vector embeddings having the closest matches,
providing to the language model the broader or the narrower version of the claim constructions and the chunks of documentation associated with the vector embeddings of the closet matches, and
generating the claim chart comprising the broader of narrower version of the claim constructions and the chunks of documentation associated with the closet matches.

16. The method of claim 7 wherein the step of storing the plurality of versions of the claim constructions in a second data structure comprises storing the plurality of versions of the claim constructions in a tree, graph or table data structure.

17. The method of claim 13 further comprising generating an infringement claim chart wherein the documentation associated with the vector embeddings having the closest matches is product documentation of infringing products.

18. The method of claim 13 further comprising generating a validity claim chart wherein the documentation associated with the vector embeddings having the closest matches is prior art documentation.

19. A method for orchestrating use of a language model to generate an infringement claim chart for a patent on one or more infringing products comprising:
providing the patent and a file history of the patent to the language model,
generating a first version the claim constructions of the patent and a summary of the patent by supplying a prompt comprising the patent and the file history to the language model,
creating a vector embedding for each limitation of the first version of the claim constructions,
crawling the internet for documentation on one or more infringing products using the first version of the claim constructions and the summary of the patent,
chunking the documentation for the one or more infringing products to generate chunks of documentation comprising content obtained from corresponding portions of the documentation and storing the chunks of documentation in a vector data structure,
for each chunk of documentation, creating a vector embedding, and storing the vector embedding in the vector data structure,
for each vector embedding of the first version of the claim constructions and the vector embeddings stored in the vector data structure, identifying the vector embeddings having the closest matches,
retrieving from the vector data structure the chunks of documentation associated with the vector embeddings having the closest matches,
providing the language model the first version of the claim constructions and the chunks of documentation associated with the closet matches, and
using the language model to generate the infringement claim chart comprising the first version of the claim constructions and the chunks of documentation associated with the closet matches.

20. The method of claim 19 further comprising:
generating a plurality of the claim constructions that are narrower than the first version,
generating a plurality of the claim constructions that are broader than the first version, and
storing in a second data structure the plurality of versions of the claim constructions so that each of the versions is retrievable.

21. The method of claim 20 further comprising:
crawling the internet for documentation for one or more infringing products using a broader or a narrower version of the claim constructions stored in the second data structure and a summary of the patent,
chunking the documentation for the one or more infringing products and storing the chunks of documentation in the vector data structure,
for each chunk of documentation, creating a vector embedding, and storing the vector embedding in the vector data structure,
creating a vector embedding for each limitation of the broader or the narrower version of the claim constructions,
retrieving from the vector data structure the chunks of documentation associated with the vector embeddings having the closest matches,
for each vector embedding of the broader or the narrower version of the claim constructions and the vector embeddings stored in the vector data structure, identifying the vector embeddings having the closest matches,
providing to the language model the broader or the narrower version of the claim constructions and the chunks of documentation associated with the vector embeddings of the closet matches, and
generating the infringement claim chart with the broader or narrower version of the claim constructions and the chunks of documentation associated with the closet matches.

22. The method of claim 20 wherein the step of storing the plurality of versions of the claim constructions in a vector data structure comprises storing the plurality of versions of the claim constructions in a graph, tree or table data structure.

23. A method for orchestrating use of a language model to generate a validity claim chart for a patent with one or more prior art references comprising:
providing the patent and a file history of the patent to the language model,
generating a first version of claim constructions of the patent and a summary of the patent by supplying a prompt comprising the patent and the file history to the language model,
creating a vector embedding for each limitation of the first version of the claim constructions,
crawling the internet for documentation on one or more prior art references using the first version of the claim constructions and the summary of the patent,
chunking the documentation for the one or more prior art references to generate a plurality of chunks of documentation comprising content obtained from corresponding portions of the documentation and storing the chunks of documentation in a vector data structure,
for each chunk of documentation, creating a vector embedding, and storing the vector embeddings in the vector data structure,
for each vector embedding of the first version of the claim constructions and the vector embeddings stored in the vector data structure, identifying the vector embeddings having the closest matches,
retrieving from the vector data structure the chunks of documentation associated with the vector embeddings having the closest matches,
providing the language model the first version of the claim constructions and the chunks of documentation associated with the closet matches, and
using the language model to generate the validity claim chart comprising the first version of the claim constructions and the chunks of documentation associated with the closet matches.

24. The method of claim 23 further comprising:
generating a plurality of the claim constructions that are narrower than the first version,
generating a plurality of the claim constructions that are broader than the first version, and
storing in a second data structure the plurality of versions of the claim constructions so that each of the versions is retrievable.

25. The method of claim 24 further comprising:
crawling the internet for documentation for one or more prior art references using a broader or a narrower version of the claim constructions stored in the second data structure and a summary of the patent,
chunking the documentation for one or more infringing products to generate a second plurality of chunks of documentation comprising content obtained from corresponding portions of the documentation and storing the second plurality of chunks of documentation in the vector data structure,
for each chunk of documentation, creating a vector embedding, and storing the vector embedding in the vector data structure,
creating a vector embedding for each limitation of the broader or the narrower version of the claim constructions,
retrieving from the vector data structure the chunks of documentation associated with the vector embeddings having the closest matches,
for each vector embedding of the broader or the narrower version of the claim constructions and the vector embeddings stored in the vector data structure, identifying the vector embeddings having the closest matches,
providing to the language model the broader or the narrower version of the claim constructions and the chunks of documentation associated with the vector embeddings of the closet matches, and
generating the validity claim chart comprising the broader or the narrower version of the claim constructions and the chunks of documentation associated with the closet matches.

26. The method of claim 24 wherein the step of storing the plurality of versions of the claim constructions in a second data structure comprises storing the plurality of versions of the claim constructions in a tree, graph or table data structure.

27. A method for orchestrating use of a language model to generate a claim construction that is optimized for the highest probability of infringement and lowest probability of invalidating a patent comprising:
providing the patent and a file history of the patent to the language model,
generating a first version the claim constructions of the patent and a summary of the patent by supplying a prompt comprising the patent and the file history to the language model,
creating a vector embedding for each limitation of a first version of the claim constructions,
crawling for documentation on one or more prior art references using the first version of the claim constructions and the summary of the patent,
crawling for documentation on one or more infringing products using the first version of the claim constructions and the summary of the patent,
chunking the documentation to generate a plurality of chunks of documentation comprising content obtained from corresponding portions of the documentation and storing the chunks of documentation in a vector data structure,
for each chunk of documentation, creating a vector embedding, and storing the vector embeddings in the vector data structure,
for each vector embedding of the first version of the claim constructions and the vector embeddings stored in the vector data structure, identifying the vector embeddings having the closest matches,
retrieving from the vector data structure the chunks of documentation associated with the vector embeddings having the closest matches,
providing the language model the first version of the claim constructions and the chunks of documentation associated with the closet matches,
using the language model to generate a first version of a validity claim chart and a second version of an infringement chart comprising the first version of the claim constructions and the chunks of documentation associated with the closet matches,
generating a plurality of the claim constructions that are narrower than the first version,
generating a plurality of the claim constructions that are broader than the first version,
storing in a second data structure the plurality of versions of the claim constructions so that each of the versions is retrievable,
crawling for documentation for one or more prior art references using a broader or a narrower version of the claim constructions stored in the second data structure and a summary of the patent,
crawling for documentation for one or more prior art references using a broader or a narrower version of the claim constructions stored in the second data structure and a summary of the patent,
chunking the documentation for the one or more infringing products to generate a second plurality of chunks of documentation comprising content obtained from corresponding portions of the documentation and storing the second plurality of chunks of documentation in the vector data structure,
for each chunk of documentation, creating a vector embedding, and storing the vector embedding in the vector data structure,
creating a vector embedding for each limitation of the broader or the narrower version of the claim constructions,
retrieving from the vector data structure the chunks of documentation associated with the vector embeddings having the closest matches,
for each vector embedding of the broader or the narrower version of the claim constructions and the vector embeddings stored in the vector data structure, identifying the vector embeddings having the closest matches,
providing to the language model the broader or the narrower version of the claim constructions and the chunks of documentation associated with the vector embeddings of the closet matches,
generating a second version of the validity claim chart and a second version of the infringement chart comprising the broader or the narrower version of the claim constructions and the chunks of documentation associated with the closet matches, and
determining the patent claim construction that provides the highest probability of infringement and lowest probability of invalidating a patent.

28. The method of claim 27 wherein the step of storing the plurality of versions of the claim constructions in a second data structure comprises storing the plurality of versions of the claim constructions in a tree, graph or table data structure.

29. The method of claim 27 further comprising ranking the patent claim constructions in order of the highest probability of infringement and lowest probability of invalidating the patent and storing each of the versions of the infringement claim charts and validity claim charts in a second data structure.

30. A method for orchestrating use of a language model to generate a claim construction that is optimized for lowest probability of infringement and highest probability of invalidating a patent comprising:
providing the patent and a file history of the patent to the language model,
generating a first version of claim constructions of the patent and a summary of the patent by supplying a prompt comprising the patent and the file history to the language model,
creating a vector embedding for each limitation of a first version of the claim constructions,
crawling for documentation on one or more prior art references using the first version of the claim constructions and the summary of the patent,
crawling for documentation on one or more infringing products using the first version of the claim constructions and the summary of the patent,
chunking the documentation to generate a plurality of chunks of documentation comprising content obtained from corresponding portions of the documentation and storing the chunks of documentation in a vector data structure,
for each chunk of documentation, creating a vector embedding, and storing the vector embeddings in the vector data structure,
for each vector embedding of the first version of the claim constructions and the vector embeddings stored in the vector data structure, identifying the vector embeddings having the closest matches,
retrieving from the vector data structure the chunks of documentation associated with the vector embeddings having the closest matches,
providing the language model the first version of the claim constructions and the chunks of documentation associated with the closet matches, and
using the language model to generate a first version of a validity claim chart and an second version of an infringement chart comprising the first version of the claim constructions and the chunks of documentation associated with the closet matches,
generating a plurality of the claim constructions that are narrower than the first version,
generating a plurality of the claim constructions that are broader than the first version,
storing in a second data structure the plurality of versions of the claim constructions so that each of the versions is retrievable,
crawling for documentation for one or more prior art references using a broader or a narrower version of the claim constructions stored in the second data structure and a summary of the patent,
crawling for documentation for one or more prior art references using a broader or a narrower version of the claim constructions stored in the second data structure and a summary of the patent,
chunking the documentation for the one or more infringing products and storing the chunks of documentation in the vector data structure,
for each chunk of documentation, creating a vector embedding, and storing the vector embedding in the vector data structure,
creating a vector embedding for each limitation of the broader or the narrower version of the claim constructions,
retrieving from the vector data structure the chunks of documentation associated with the vector embeddings having the closest matches,
for each vector embedding of the broader or the narrower version of the claim constructions and the vector embeddings stored in the vector data structure, identifying the vector embeddings having the closest matches,
providing to the language model the broader or the narrower version of the claim constructions and the chunks of documentation associated with the vector embeddings of the closet matches,
generating a second version of the validity claim chart and a second version of the infringement chart comprising the broader or the narrower version of the claim constructions and the chunks of documentation associated with the closet matches, and
determining the patent claim construction that provides the lowest probability of infringement and highest probability of invalidating a patent.

31. The method of claim 30 wherein the step of storing the plurality of versions of the claim constructions in a second data structure comprises storing the plurality of versions of the claim constructions in a tree, graph or table data structure.

32. The method of claim 30 further comprising ranking the patent claim constructions in order of the lowest probability of infringement and highest probability of invalidating the patent and storing each of the versions of the infringement claim charts and validity claim charts in a second data structure.

33. The method of claim 1, wherein chunking the documentation comprises performing semantic chunking or hierarchical chunking.

34. The method of claim 33, wherein hierarchical chunking comprises receiving sections of the documentation, identified based on section headings, as chunks of the chunks, and
wherein semantic chunking comprises receiving sentences or paragraphs of the documentation as chunks of the chunks.

35. The method of claim 19, wherein chunking the documentation comprises performing semantic chunking or hierarchical chunking.

36. The method of claim 35, wherein hierarchical chunking comprises receiving sections of the documentation, identified based on section headings, as chunks of the chunks, and
wherein semantic chunking comprises receiving sentences or paragraphs of the documentation as chunks of the chunks.

37. The method of claim 23, wherein chunking the documentation comprises performing semantic chunking or hierarchical chunking.

38. The method of claim 37, wherein hierarchical chunking comprises receiving sections of the documentation, identified based on section headings, as chunks of the chunks, and
wherein semantic chunking comprises receiving sentences or paragraphs of the documentation as chunks of the chunks.

39. The method of claim 27, wherein chunking the documentation comprises performing semantic chunking or hierarchical chunking.

40. The method of claim 39, wherein hierarchical chunking comprises receiving sections of the documentation, identified based on section headings, as chunks of the chunks, and
wherein semantic chunking comprises receiving sentences or paragraphs of the documentation as chunks of the chunks.
